(19) United States
(12) Patent Application Publication
(10) Pub. No.: US 2024/0077856 A1
(43) Pub. Date: Mar. 7, 2024

(54) MANAGEMENT OF RUNTIME CONTAINERS FOR AN INDUSTRIAL AUTOMATION SYSTEM

(71) Applicant: WAGO Verwaltungsgesellschaft mbH, Minden (DE)

(72) Inventors: Thomas HOLM, Rinteln (DE); Jan JENKE, Herford (DE); Nikolai FALKE, Porta Westfalica (DE)

(73) Assignee: WAGO Verwaltungsgesellschaft mbH, Minden (DE)

(21) Appl. No.: 18/388,315

(22) Filed: Nov. 9, 2023

Related U.S. Application Data
(63) Continuation of application No. PCT/EP2022/062785, filed on May 11, 2022.

(30) Foreign Application Priority Data
May 11, 2021 (DE) 10 2021 204 757.2

(51) Int. Cl. G05B 19/418

(52) U.S. Cl. CPC G05B 19/4188; G05B 19/4183

(57) ABSTRACT

A method in an industrial automation system, the method including: transmitting an input data set from an industrial control device to a container manager, the input data set comprising at least input metadata; determining, by the container manager, based on the input metadata, a runtime container for processing input data; generating, by an application of the runtime container, output data based on the input data; generating an output data set by using the container manager, the output data set comprising at least output metadata; and transmitting the output data set from the container manager to the industrial control device.

This nonprovisional application is a continuation of International Application No. PCT/EP2022/062785, which was filed on May 11, 2022, and which claims priority to German Patent Application No. 10 2021 204 757.2, which was filed in Germany on May 11, 2021, and which are both herein incorporated by reference.

### BACKGROUND OF THE INVENTION

### Field of the Invention

The invention relates generally to the field of industrial automation technology and, in particular, to methods and techniques for the dynamic management of runtime containers for the operation of an industrial automation system.

### Description of the Background Art

In the field of general information technology (IT), techniques are already known for developing applications quickly and independently of the underlying hardware infrastructure. For example, approaches such as “continuous deployment” serve to manage complex software projects in widely distributed computer infrastructures. These approaches are typically supported by software applications encapsulated in so-called “containers”. In contrast to virtual machines, the latter virtualise the operating system instead of the hardware and thereby enable software to be designed to be portable and efficient. One technology that is often used in this case is, for example, the Docker technology, which is primarily oriented toward virtualisation with Linux.

In another technical field, namely industrial automation technology (AT), these approaches have hardly been used to date. On the other hand, in the course of the fourth industrial revolution and the all-encompassing digitization, cloud solutions are also increasingly being used in industrial automation technology for analysis, management and in some cases even for controlling the components of automation environments. In this case, data are usually generated by industrial control devices at runtime and sent to one or more cloud systems. An industrial control device may be, for example, a programmable logic controller (PLC). Such a device is typically communicatively connected to one or more sensors and/or actuators and performs tasks in the context of automation technology. Within the scope of the invention, a cloud system may generally comprise a computer system remote from the control device. Examples which may be mentioned are the WAGO cloud, Microsoft Azure, Amazon AWS (“Amazon Web Services”), the SAP cloud or the IBM cloud. Within the cloud system, the received data are usually stored, evaluated and/or made available to users conditioned for any desired terminal devices.

For example, from EP 3 249 481 B1, which corresponds to U.S. Pat. No. 10,353,348, a system for performing a closed control loop on data for cloud-based applications is known. It describes how an industrial control interacts with a cloud environment and forms a closed control loop in order to perform complex calculations in a cloud without burdening the industrial control. This is achieved in that so-called cloud variables are generated in the control, which are forwarded by a cloud agent in the control for processing in the cloud. In this case, however, EP 3 249 481 B1 considers the processing logic on the industrial control and the cloud application in each case as monolithic components which have hardly any influence on one another.

### SUMMARY OF THE INVENTION

It is therefore an object of the present invention to provide methods which allow an industrial control device to access external resources more flexibly.

In an exemplary embodiment, a method in an industrial automation system is provided in that an industrial control device sends an input data set to a container manager, wherein the input data set comprises at least (or also only) input metadata. The container manager determines, based on the input metadata, a runtime container for processing input data from the industrial control device. Output data are generated based on the input data by an application of the runtime container. The container manager generates an output data set, wherein the output data set comprises at least output metadata. The container manager sends the output data set to the industrial control device.

In a particularly simple implementation, the input data to be processed may be sent directly in the input data set from the industrial control device to the container manager, which may then send them to the runtime container. In this embodiment, however, the data exchange via the container manager may represent a bottleneck with respect to the data transmission, whereby the communication effort may be increased. It is therefore alternatively provided that the container manager may send an address of the runtime container to the industrial control device. Optionally, an address of the industrial control device may be communicated to the runtime container. This address may be contained in the metadata of the control device or alternatively be determined by the container manager. The input data may then be transmitted from the industrial control device directly to the runtime container (i.e. without participation of the container manager) and optionally an address of the control device may be transmitted.

At least two possibilities are also provided for the communication of output data. In a simple implementation, the runtime container may send the generated output data to the container manager, which in turn sends them in the output data set to the industrial control device. In this case, the same disadvantages arise with respect to the container manager as bottleneck as already described on the input side. It is therefore alternatively provided that the runtime container may send the output data directly to an address of the control device. The address may be known either directly from the control program or by the container manager.

Of course, both approaches described above may also be mixed, i.e. the communication of the input data may take place via the container manager, wherein the output data are transmitted directly, and vice versa.

The invention therefore relates to a method and apparatuses in which an industrial control device, in particular a functional module thereof, for example from an IEC programming, preferably IEC 61131, is set up in such a way as to access external resources.

In general, exemplary embodiments of the invention comprise orchestrating, i.e. initiating, configuring, monitoring and/or stopping (software) applications encapsulated in containers from an industrial controller, preferably by the control logic of the real-time system located on the industrial controller. The (software) application encapsulated in a container may in this case also be executed on another hardware infrastructure (for example in a cloud).

By virtue of the possibility of initiating, monitoring and/or stopping (software) applications encapsulated in containers from the PLC program of the industrial control device, the systems (IT and AT) are further combined with one another. Furthermore, software components may be dynamically loaded, switched off and/or removed from the PLC program by using container technologies. The latter enables consistent use of the memory. In addition, the outsourcing of software applications encapsulated in containers provides a bridge between software components which have been implemented in different programming languages and software platforms.

A method performed by a container manager in an industrial automation system is likewise provided. This method comprises: receiving an input data set from an industrial control device, wherein the input data set comprises at least input metadata; determining, based on the input metadata, a runtime container for processing input data; generating an output data set, wherein the output data set comprises at least output metadata; and sending the output data set to the industrial control device.

A corresponding method performed by an industrial control device in an industrial automation system comprises: sending an input data set to a container manager, wherein the input data set comprises at least input metadata, wherein the input metadata allows the container manager to determine a runtime container for generating output data based on input data; receiving an output data set from the container manager, wherein the output data set comprises at least output metadata.

The input metadata may comprise a container type. Based on the container type, the developer of the runtime program on the industrial control device may define which functionality is to be offloaded into a container.

The input metadata may also comprise an input identifier, for example a timestamp, wherein the output data set comprises output metadata, and wherein the output metadata comprise the same input identifier as the associated input metadata. This serves to assign the output data generated by the container to the original input data (for example by a timestamp). This enables synchronization despite the asynchronous mode of operation.

Further, the input metadata may comprise a return address, a container identifier and/or a policy. A policy may define under which conditions a new container is to be initiated, an existing container is to be restarted, stopped and/or removed, and enables the control device or its programmer to have extensive control over the containers.

If the output data set comprises output metadata, these may also comprise a status.

The determining a runtime container for processing the input data may comprise initiating a new runtime container or selecting an already running runtime container.

Further, the determining a runtime container for processing the input data may be based on a current utilization of processing resources for operating runtime containers.

The invention further provides a system in its entirety and the above-mentioned apparatuses, for performing the methods described here. In addition, a computer program comprising instructions for implementing the methods described here is provided.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic illustration of a system environment for an example of the invention; and

FIG. 2 is a schematic illustration of a system environment for an example of the invention.

### DETAILED DESCRIPTION

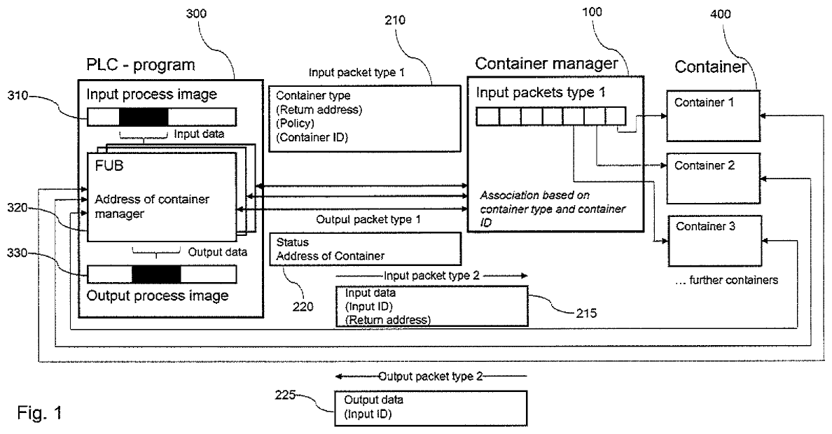

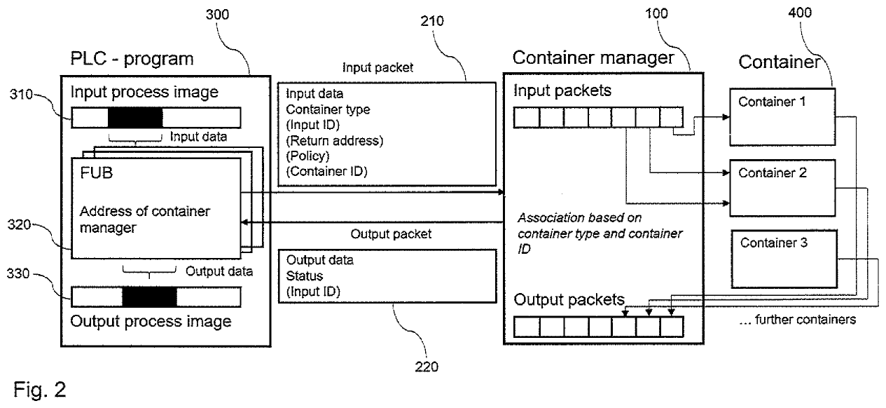

FIGS. 1 and 2 show two examples of an automation system. In both examples, the system comprises an industrial control device 300, which may be, for example, a programmable logic controller (PLC). Such a device 300 is typically communicatively connected to one or more sensors and/or actuators and performs tasks in the context of automation technology. In this case, an input process image 310 can be created from the sensor data and an output process image 330 can be generated by corresponding processing.

Within the control logic of the industrial controller 300, a function module (see the module “FUB” in FIG. 1) 320 is configured for communication with the container manager 100. Via the module 320, data from the control logic can be selected and forwarded to the container manager 100 in a predefined format as input data set 210 (see the “input packet type 1” in FIG. 1 and the “input packet” in FIG. 2).

In both embodiments (FIGS. 1 and 2), such input packets 210 comprise at least input metadata. These input metadata may comprise:
A selected container type, which indicates the type of container that is to provide the desired functionality (e.g., specific algorithm). The container type may either be predefined by the function module 300 or, in the case of a generic function module 300, be specified by the user. Examples of container types may be: anomaly detection algorithms, prediction functions, methods for phase analysis of the power consumption of cyclic/periodic processes, neural networks, trend/drift detection, dashboards, data loggers and/or programs of other companies in a defined container.
A unique input identifier (see “Input ID” in FIG. 2), in order to be able to assign the input packet and the function module to the output later on.
A return address (if necessary).
A container identifier (see “Container ID” in FIGS. 1 and 2; optional and depending on the specific implementation).
An optional policy with one or more variables. Such policies may inter alia define under which conditions a new container is initiated, an existing container is restarted, stopped and/or removed.

Example 1: As soon as no more data are sent to the container over a defined period of time, the container is ended.

Example 2: As soon as no more data are sent to the container over a defined period of time, the container is removed.

Example 3: The container is never terminated and deleted, except by an explicit command.

Example 4: The container may be used by a plurality of FUBs+combinations with examples 1-3.

Example 5: The container may be used by only one FUB+combinations with examples 1-3.

It shall be understood that only subsets of the above data may be used as metadata.

In the example according to FIG. 2, the input packet 210 further also comprises the actual input data from the control logic (hereinafter also referred to as “input data”), i.e. those data which are to be processed. In the example according to FIG. 1, the input data are sent separately from the control device 300 to the corresponding container 400 (see the “input packet type 2” 215 in FIG. 1).

An exemplary implementation of the data communication in the JSON format is described below:

First Connection to the Container Manager:
Json
Topic: Container Manager
Payload: {‘returnAddress’: ‘ . . . ’, ‘containerType’: ‘ . . . ’, policy: ‘ . . . ”, ‘containerConfig’: ‘ . . . ’, ‘projectID’: ‘ . . . ’}

Notification from the container manager to FUB— Permanent subscription of the FUB to get status changes. Container Manager provides permanent status information so that the FUB can derive actions when no more status information arrive:
Topic: ‘PfcId1/InstanceId1’
Payload: {‘time’: ‘ . . . ’, ‘containerStatus’: ‘ . . . ’, ‘inputAddress’: ‘ . . . ’, ‘outputAddress’: ‘ . . . ’,}

Data from the FUB:
Topic: “ . . . ”
Payload: {‘data’: [{‘time’: ‘2020-06-29T09:09:54.874Z’, ‘value1’: 1.2, ‘value2’: 1.4, . . . , ‘xyz’: [221, 213, 213]}],
‘outputAddress’: ‘ . . . ’,
‘sourceID’: ‘ . . . ’}

Data from the Model:
Topic: ‘PfcId1/InstanceId1/output’
Payload: {‘data’: [{‘time’: ‘2020-06-29T09:09:54.874Z’, ‘result1’:1.23, ‘result2’:2.34}],}

The task of the container manager 100 is to manage the available containers 400 taking into account the available resources and to forward the incoming input packets 210 to the containers 400. When the container manager 100 receives a new input 210, it decides whether a container 400 is initiated based on the container type, the policy and/or the container ID. If a container of this type does not yet exist for the requested container type, a container of this type is typically initiated. If a container already exists and the policy allows the use of a “shared” container, the container may be used. It may be specified by a ContainerID that precisely one container is used with this ContainerID. If this already exists, the container is used, otherwise a new container with this ContainerID is initiated. Further rules may be adapted depending on the application.

In the example according to FIG. 2, the input data are forwarded to the corresponding container 400. The assignment of the data packets preferably takes place according to the container type and the container ID.

In the example according to FIG. 2, the containers 400 return their results to the container manager 100 and these are inserted by the container manager 100 into output data sets 220 (see the “output packet” in FIG. 2). An output data set 220 may in this case comprise the input ID and/or the status of the corresponding container. Alternatively, the container 400 may also send the output data directly to the industrial control device 300 (see the “output packet type 2” 225 in FIG. 1). The above-mentioned status may indicate, for example, errors due to inappropriate input data or program crashes. A status which indicates that the container is still in the initialization or indicates the computing load is also conceivable.

In both examples, the container manager 100 sends the output packets 220 to the appropriate return address(es) which were specified in the input packet 210.

The function module 320 may subsequently make these data available to the control logic of the industrial controller 300 so that the data are processed there.

In order to enable a particularly efficient distribution of the utilization, the container manager 100 may distribute containers 400, in particular stateless containers, to the hardware available to it so that these may be used in parallel. For this purpose, the container manager 100 may identify the load of the incoming input packets 210 and initiate a further (identical) container 400 if necessary. This distributes the load to a plurality of containers 400.

The container manager 100 may also be responsible for terminating and/or removing containers 400 which are no longer required or, if necessary, creating no new containers 400 and rejecting requests from the function modules 320, for example if the hardware is too heavily loaded to operate further containers. In this case, the container manager 100 may take into account the policies which are contained in the input packets 210.

Also, further functionalities for direct response of the container manager 100 via additional function modules 320 may be enabled, for example the container initiation, container update, deletion as well as termination of the container and/or an overview of the current container status.

In summary, in an example, the invention provides function modules 320 which may be selected by the (IEC) programmer and processed with an SW/HW resource. Everything else is handled by the container manager 100. The container manager 100 manages the SW/HW resources and selects, based on the metadata stored in the function modules 320, which SW/HW resources are required for the functions required in the function module 320. These SW/HW resources may be located both in a cloud or in an automation network or in a regular IT cluster.

Exemplary use scenarios are explained below:

Anomaly detection: An anomaly detection algorithm may be computationally intensive and implemented in a special programming language so that it is to be operated in a container distinct from the industrial controller. In this example, the input data could be temperatures and/or vibration. These data are evaluated by the anomaly detection algorithm and the evaluation is sent to the industrial controller. In this case, a function module may be used in the usual manner since ideally the container manager provides the anomaly detection in a container in the background. The function module communicates below with the anomaly detection container and forwards the results to the control program.

Integration of a third party: A container may be provided by the container manager which directly receives the data of the function module and sends the results thereto, for example a container comprising a low-code development environment, such as a node RED container.

Dashboard: A dashboard container may be provided by the container manager which directly receives and visualizes the data of the function module. This enables an insight into the process data without or with minimal outlay.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method in an industrial automation system, the method comprising:
sending an input data set from an industrial control device to a container manager, the input data set comprising at least input metadata;
determining, by the container manager and based on the input metadata, a runtime container for processing input data;
generating output data based on the input data by an application of the runtime container;
generating an output data set by the container manager, the output data set comprising at least output metadata; and
sending the output data set from the container manager to the industrial control device.

2. A method performed by a container manager in an industrial automation system, the method comprising:
receiving an input data set from an industrial control device, the input data set comprising at least input metadata;
determining, based on the input metadata, a runtime container for processing input data;
generating an output data set, the output data set comprising at least output metadata; and
sending the output data set to the industrial control device.

3. A method performed by an industrial control device in an industrial automation system, the method comprising:
sending an input data set to a container manager, the input data set comprising at least input metadata, the input metadata facilitating the container manager to determine a runtime container to generate output data based on input data; and
receiving an output data set from the container manager, the output data set comprising at least output metadata.

4. The method according to claim 1, wherein the input metadata comprise a container type.

5. The method according to claim 1, wherein the input metadata comprise an input identifier or a timestamp, wherein the output data set comprises output metadata, and wherein the output metadata comprise the same input identifier as the associated input metadata.

6. The method according to claim 1, wherein the input metadata comprise a return address.

7. The method according to claim 1, wherein the input metadata comprise a container identifier.

8. The method according to claim 1, wherein the input metadata comprise a policy.

9. The method according to claim 1, wherein the output data set comprises output metadata and the output metadata comprise a status.

10. The method according to claim 1, wherein the determining a runtime container for processing the input data comprises:
initiating a new runtime container; or
selecting an already running runtime container.

11. The method according to claim 1, wherein the determining a runtime container for processing the input data is further based on a current utilization of processing resources for operating runtime containers.

12. A system or an apparatus to perform the method according to claim 1.

13. A computer program comprising instructions which, when the program is executed by a computer, cause the computer to carry out the method according to claim 1.
